(19) United States
(12) Patent Application Publication
(10) Pub. No.: US 2021/0388739 A1
(43) Pub. Date: Dec. 16, 2021

(54) COMPOSITE FAN CONTAINMENT CASE

(71) Applicant: General Electric Company, Schenectady, NY (US)

(72) Inventors: Arvind Namadevan, Bangalore (IN); Arnab Sen, Bangalore (IN); Wendy Wenling Lin, Montgomery, OH (US); Shivam Mittal, Bangalore (IN); Peeyush Pankaj, Bangalore (IN); Shashank Suresh Puranik, Bangalore (IN); Narayanan Payyoor, Bangalore (IN); Praveen Sharma, Bangalore (IN)

(21) Appl. No.: 16/902,480

(22) Filed: Jun. 16, 2020

(51) Int. Cl. F01D 25/24

(52) U.S. Cl. CPC F01D 25/24; F05D 2220/36; F05D 2250/283; F05D 2300/44; F05D 2300/603

(57) ABSTRACT

A composite fan casing for a gas turbine engine defining a central axis is generally provided. The composite fan casing includes a core having a plurality of core layers of reinforcing fibers bonded together with a thermosetting polymeric resin, wherein one or more of the plurality of core layers of reinforcing fibers comprises a shear thickening fluid. The core layer may include at least one fabric sheet comprising the reinforcing fibers.

### FIELD

The present subject matter relates generally to the fan containment case of a gas turbine engine and, more particularly, to a multi-layer composite core structure for a composite fan containment case of a gas turbine engine.

### BACKGROUND

A gas turbine engine generally includes a fan and a core arranged in flow communication with one another. Additionally, the core of the gas turbine engine generally includes, in serial flow order, a compressor section, a combustion section, a turbine section, and an exhaust section. In operation, air is provided from the fan to an inlet of the compressor section where one or more axial compressors progressively compress the air until it reaches the combustion section. Fuel is mixed with the compressed air and burned within the combustion section to provide combustion gases. The combustion gases are routed from the combustion section to the turbine section. The flow of combustion gases through the turbine section drives the turbine section and is then routed through the exhaust section, e.g., to atmosphere. Turbofan gas turbine engines typically include a fan assembly that channels air to the core gas turbine engine, such as an inlet to the compressor section, and to a bypass duct. Gas turbine engines, such as turbofans, generally include fan cases surrounding a fan assembly including the fan blades.

In most turbofan engines, the fan is contained by a fan case that is equipped with a shroud. The shroud circumscribes the fan and is adjacent to the tips of the fan blades. The shroud serves to channel incoming air through the fan so as to ensure that most of the air entering the engine will be compressed by the fan. A small portion of the air is able to bypass the fan blades through a radial gap present between the tips of the fan blades and the shroud. The radial gap is very narrow such that the amount of air that is able to bypass the fan through the gap is limited. The efficiency of the engine can be significantly improved in this way. Because the gap is narrow, the fan blades may rub the shroud during the normal operation of an aircraft turbofan engine. Further, the fan blades of a gas turbine engine can be susceptible to extreme loading events. For instance, a fan blade might strike a bird that is ingested into the engine, or a blade-out occurrence may arise wherein one of the fan blades is severed from a rotor disk. If the impact is large enough, a fan blade may contact the fan case.

Fan cases are generally configured to withstand an impact of the fan blades due to adverse engine conditions resulting in a failure mode, such as foreign object damage, hard rubs due to excessive or extreme unbalance or fan rotor oscillations, or fan blade liberation. One objective of fan cases is to provide adequate retention of fan blade fragments without increasing the overall weight of the shroud. Fan cases typically include one or more composite layers, i.e., Kevlar or carbon fiber sheets bonded together. However, as multiple layers of composite materials are bonded together to form the fan case, the fan case can become heavy. Furthermore, additional stiffening materials added to the composite material layers may further add to the weight of the fan case.

As such, there exists a need for composite structures for gas turbine engine components, particularly for use in a fan casing, that may maintain or improve structural performance, while having reduced weight that still provides suitable damping when exposed to certain high impact loads and effectively retains fan blade fragments.

### BRIEF DESCRIPTION

Aspects and advantages will be set forth in part in the following description, or may be obvious from the description, or may be learned through practice of the invention.

In one aspect, the present subject matter is directed to a composite fan casing for a gas turbine engine defining a central axis. The composite fan casing includes a core having a plurality of core layers of reinforcing fibers bonded together with a thermosetting polymeric resin. One or more of the core layers includes reinforcing fibers that contain a shear thickening fluid. The core layers may also include a fabric sheet that is composed of a network of the reinforcing fibers.

The reinforcing fibers may include para-aramid synthetic fibers, ultra-high molecular weight polyethylene fibers, metal fibers, ceramic fibers, glass fibers, carbon fibers, boron fibers, p-phenyleneterephthalamide fibers, aromatic polyamide fibers, silicon carbide fibers, graphite fibers, nylon fibers, or mixtures thereof. The thermosetting polymeric resin can include an epoxy resin. The network of reinforcing fibers can be impregnated with the shear thickening fluid.

In some embodiments, the shear thickening fluid may include a flowable liquid containing particles suspended in a carrier. The particles may have an average diameter of about 1 nm to about 1000 μm. The particles may contain polymer particles, silica, kaolin clay, calcium carbonate, titanium dioxide, or mixtures thereof. The silica particles may comprise fumed silica. The carrier may include ethylene glycol.

In another aspect, the present subject matter is directed to a gas turbine engine defining a central axis. The gas turbine engine includes an engine shaft extending along the central axis and a compressor attached to the engine shaft and extending radially about the central axis. The gas turbine engine further includes a fan section including a plurality of fan blades drivingly coupled to the engine shaft. Moreover, each of the fan blades extends between a root and a tip in a radial direction relative to the engine shaft. The gas turbine engine also includes a combustor positioned downstream of the compressor to receive a compressed fluid therefrom. Further, the gas turbine engine includes a turbine mounted on the engine shaft downstream of the combustor to provide a rotational force to the compressor and fan section. Additionally, the gas turbine engine includes a composite fan casing radially surrounding the plurality of fan blades of the fan section. The composite fan casing includes a core having a plurality of core layers of reinforcing fibers bonded together with a thermosetting polymeric resin. One or more of the core layers includes reinforcing fibers that contain a shear thickening fluid. The core layers may also include a fabric sheet that is composed of a network of the reinforcing fibers.

These and other features, aspects and advantages will become better understood with reference to the following description and appended claims. The accompanying drawings, which are incorporated in and constitute a part of this specification, illustrate embodiments of the invention and, together with the description, serve to explain certain principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended FIGS., in which:

FIG. 1 illustrates a cross-sectional view of one embodiment of a gas turbine engine that may be utilized within an aircraft in accordance with aspects of the present subject matter, particularly illustrating the gas turbine engine configured as a high-bypass turbofan jet engine;

FIG. 2 illustrates a cross-sectional view of the fan section of FIG. 1 in accordance with aspects of the present subject matter, particularly illustrating a composite fan containment casing of a fan section of the gas turbine engine;

FIG. 3 illustrates one embodiment of the composite fan containment casing of FIG. 2, particularly illustrating a schematic cross-section of the composite fan containment casing in radial and axial directions of the gas turbine engine;

FIG. 4 illustrates a schematic cross-section of a portion of an exemplary embodiment of the composite fan containment casing in accordance with aspects of the present subject matter, particularly illustrating the composite fan containment casing formed from a plurality of layers;

FIG. 5 illustrates a schematic cross-section of a portion of another exemplary embodiment of the composite fan containment casing in accordance with aspects of the present subject matter, particularly illustrating build-up layers bonded to an outer surface of a core of the composite fan containment casing; and

FIG. 6 illustrates a schematic cross-section of a portion of an exemplary embodiment of the composite fan containment casing in accordance with aspects of the present subject matter, particularly illustrating the composite fan containment casing formed from a plurality of layers including a honeycomb structure.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first”, “second”, and “third” may be used interchangeably to distinguish one component from another and are not intended to signify location or importance of the individual components.

The terms “upstream” and “downstream” refer to the relative direction with respect to fluid flow in a fluid pathway. For example, “upstream” refers to the direction from which the fluid flows, and “downstream” refers to the direction to which the fluid flows.

The terms “coupled,” “fixed,” “attached to,” and the like refer to both direct coupling, fixing, or attaching, as well as indirect coupling, fixing, or attaching through one or more intermediate components or features, unless otherwise specified herein.

The terms “communicate,” “communicating,” “communicative,” and the like refer to both direct communication as well as indirect communication such as through a memory system or another intermediary system.

A composite fan casing for a gas turbine engine is generally provided. The composite fan casing is generally a fan containment casing radially surrounding fan blades of a fan section of the gas turbine engine. The fan casing includes a core with one or more core layers of reinforcing fibers bonded together with a thermosetting polymeric resin. The reinforcing fibers may be woven together to form a fabric sheet that includes a network of reinforcing fibers. The reinforcing fibers may include para-aramid synthetic fibers, ultra-high molecular weight polyethylene fibers, metal fibers, ceramic fibers, glass fibers, carbon fibers, boron fibers, p-phenyleneterephthalamide fibers, aromatic polyamide fibers, silicon carbide fibers, graphite fibers, nylon fibers, or mixtures thereof.

At least one of the core layers of reinforcing fibers includes a shear thickening fluid. Multiple core layers can also include the shear thickening fluid. For example, in certain embodiments all of the core layers can include a shear thickening fluid. The shear thickening fluid may include a flowable liquid containing particles suspended in a carrier. The particles may have an average diameter of about 1 nm to about 1000 μm. The particles may include polymer particles, silica, kaolin clay, calcium carbonate, titanium dioxide, or mixture thereof. The silica particles may comprise fumed silica.

Generally, the shear thickening fluid is added to the reinforcing fibers to improve the stiffness of the reinforcing fibers, which can facilitate better blade containment in the event of a fan blade out (FBO) event and can also reduce the need for additional layers of the reinforcing fibers. Accordingly, utilization of the reinforcing fibers having the shear thickening fluid, as provided herein, can provide for a core having reduced material thickness, which may advantageously reduce the fan case diameter. Additionally, by reducing the amount of reinforcing fibers or layers present in the core of the fan containment case, the engine may have overall weight reduction, which may improve overall engine performance and design.

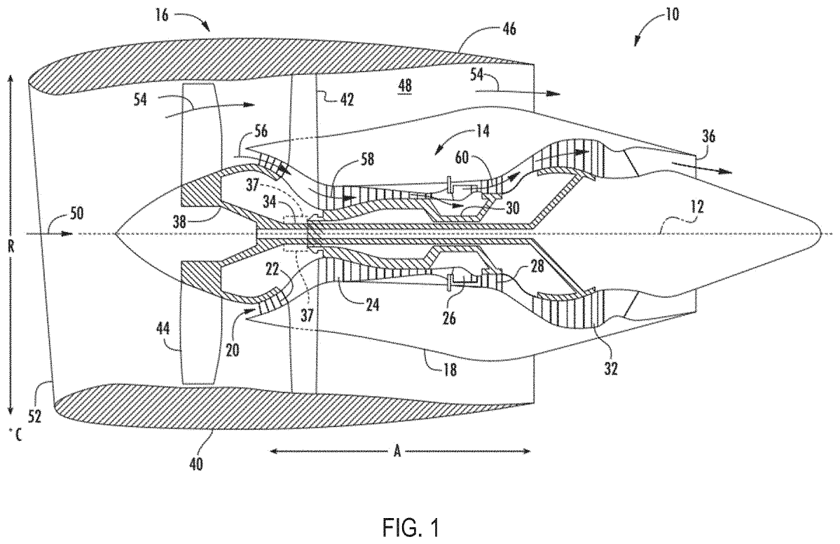

Referring now to the drawings, FIG. 1 illustrates a cross-sectional view of one embodiment of a gas turbine engine 10 that may be utilized within an aircraft in accordance with aspects of the present subject matter. More particularly, for the embodiment of FIG. 1, the gas turbine engine 10 is a high-bypass turbofan jet engine, with the gas turbine engine 10 being shown having a longitudinal or axial centerline axis 12 extending therethrough along an axial direction A for reference purposes. The gas turbine engine 10 further defines a radial direction R extending perpendicular from the centerline 12. Further, a circumferential direction C (shown in/out of the page in FIG. 1) extends perpendicular to both the centerline 12 and the radial direction R. Although an exemplary turbofan embodiment is shown, it is anticipated that the present disclosure can be equally applicable to turbomachinery in general, such as an open rotor, a turboshaft, turbojet, or a turboprop configuration, including marine and industrial turbine engines and auxiliary power units.

In general, the gas turbine engine 10 includes a core gas turbine engine (indicated generally by reference character 14) and a fan section 16 positioned upstream thereof. The core engine 14 generally includes a substantially tubular outer casing 18 that defines an annular inlet 20. In addition, the outer casing 18 may further enclose and support a low pressure (LP) compressor 22 for increasing the pressure of the air that enters the core engine 14 to a first pressure level. A multi-stage, axial-flow high pressure (HP) compressor 24 may then receive the pressurized air from the LP compressor 22 and further increase the pressure of such air. The pressurized air exiting the HP compressor 24 may then flow to a combustor 26 within which fuel is injected into the flow of pressurized air, with the resulting mixture being combusted within the combustor 26. The high energy combustion products 60 are directed from the combustor 26 along the hot gas path of the gas turbine engine 10 to a high pressure (HP) turbine 28 for driving the HP compressor 24 via a high pressure (HP) shaft or spool 30, and then to a low pressure (LP) turbine 32 for driving the LP compressor 22 and fan section 16 via a low pressure (LP) drive shaft or spool 34 that is generally coaxial with HP shaft 30. After driving each of turbines 28 and 32, the combustion products 60 may be expelled from the core engine 14 via an exhaust nozzle 36 to provide propulsive jet thrust.

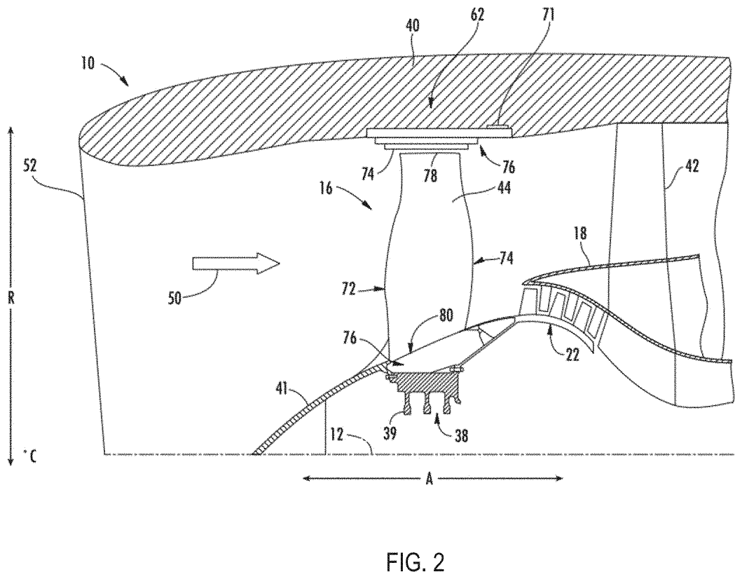

Additionally, as shown in FIGS. 1 and 2, the fan section 16 of the gas turbine engine 10 generally includes a rotatable, axial-flow fan rotor 38 configured to be surrounded by an annular nacelle 40. In particular embodiments, the LP shaft 34 may be connected directly to the fan rotor 38 or rotor disk 39, such as in a direct-drive configuration. In alternative configurations, the LP shaft 34 may be connected to the fan rotor 38 via a speed reduction device 37 such as a reduction gear gearbox in an indirect-drive or geared-drive configuration. Such speed reduction devices may be included between any suitable shafts/spools within the gas turbine engine 10 as desired or required. Additionally, the fan rotor 38 and/or rotor disk 39 may be enclosed or formed as part of a fan hub 41.

It should be appreciated by those of ordinary skill in the art that the nacelle 40 may be configured to be supported relative to the core engine 14 by a plurality of substantially radially-extending, circumferentially-spaced outlet guide vanes 42. As such, the nacelle 40 may enclose the fan rotor 38 and its corresponding fan rotor blades (fan blades 44). Further, as shown, each of the fan blades 44 may extend between a root 77 and a tip 78 in the radial direction R relative to the centerline 12. Moreover, a downstream section 46 of the nacelle 40 may extend over an outer portion of the core engine 14 so as to define a secondary, or by-pass, airflow conduit 48 that provides additional propulsive jet thrust.

During operation of the gas turbine engine 10, it should be appreciated that an initial airflow (indicated by arrow 50) may enter the gas turbine engine 10 through an associated inlet 52 of the nacelle 40. The air flow 50 then passes through the fan blades 44 and splits into a first compressed air flow (indicated by arrow 54) that moves through the by-pass conduit 48 and a second compressed air flow (indicated by arrow 56) which enters the LP compressor 22. The pressure of the second compressed air flow 56 is then increased and enters the HP compressor 24 (as indicated by arrow 58). After mixing with fuel and being combusted within the combustor 26, the combustion products 60 exit the combustor 26 and flow through the HP turbine 28. Thereafter, the combustion products 60 flow through the LP turbine 32 and exit the exhaust nozzle 36 to provide thrust for the gas turbine engine 10.

As illustrated in FIGS. 1 and 2, the gas turbine engine 10 may include a composite fan containment casing (fan casing 62) radially surrounding and circumscribing the fan blades 44. The fan casing 62 may be configured to channel the initial airflow flow 50 through the fan section 16 so as to ensure that the fan blades 44 will compress the bulk of the air entering the engine 10. Additionally, a small radial gap 76 may be present between tips 78 of the fan blades 44 and an inner annular surface 74 of the fan casing 62. Generally, the radial gap 76 may be minimized in order to promote the efficiency of the gas turbine engine 10. The inner annular surface 74 may have a generally circular cross-section and define an inner diameter of the fan casing 62.

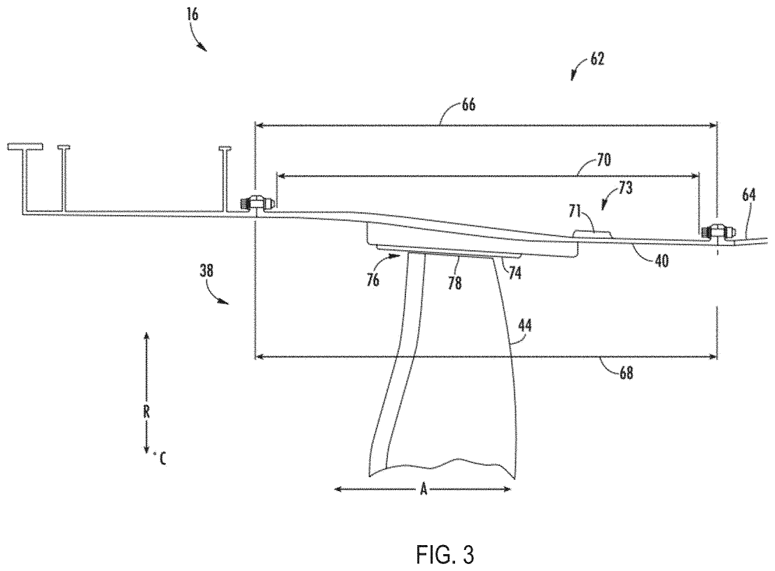

Referring now to FIG. 3, an exemplary fan casing 62 is illustrated in accordance with aspects of the present subject matter. In particular, FIG. 3 illustrates a schematic cross-section illustration of the fan casing 62 in the radial and axial directions R, A. As shown, the fan section 16 may include the forward fan case (referred to as the fan casing 62) surrounding the fan blades 44 and an aft fan casing 64 positioned aft of the fan blades 44 relative to the centerline 12 (FIG. 1). In the exemplary embodiment, fan casing 62 is a hardwall containment system that includes a length 66 that is approximately equal to a fan assembly length 68 of the fan rotor 38 (FIG. 2). More specifically, length 66 may be variably sized so that the fan casing 62 circumscribes a prime containment zone 70 of fan section 16. The prime containment zone 70, as used herein, is defined as a zone extending both axially and circumferentially around the fan rotor 38 where the fan blade(s) 44 is most likely to be ejected from fan rotor 38.

As further illustrated, the fan casing 62 may include one or more stiffeners 71 integrally coupled to an aft portion 73 of the fan casing 62 along the axial direction A relative to the fan blades 44. Generally, the stiffener(s) 71 coupled to the fan casing 62 may increase the strength or stiffness of the fan casing 62.

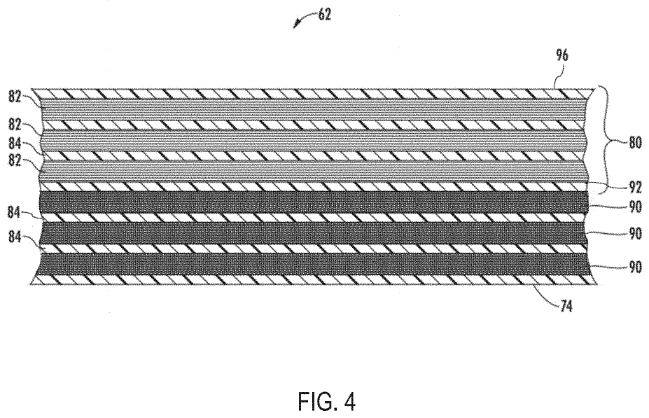

Referring now to FIG. 4, a schematic cross-section is illustrated of a portion of an exemplary embodiment of the fan casing 62. In particular, FIG. 4 includes a core 80 and a plurality of build-up layers 90 bonded to an inner surface 92 of the core 80. The inner surface 92 of the core 80 can include the surface of a layer of thermosetting polymeric resin 84. The core 80 is formed by a plurality of core layers 82 of reinforcing fibers and shear thickening fluid bonded together by a thermosetting polymeric resin 84. In some embodiments, each core layer 82 may include at least one fabric sheet comprising a network of reinforcing fibers containing shear thickening fluid. In certain embodiments, each core layer 82 may include a fabric sheet containing a plurality of braids of the reinforcing fibers containing shear thickening fluid. In certain embodiments, the core has a total thickness of from about 0.5 inches to about 5 inches. In certain embodiments, fewer than all of the core layers 82 may contain the shear thickening fluid. It may thus be understood that one, more than one but not all, or all of the core layers 82 may contain the shear thickening fluid with the reinforcing fibers.

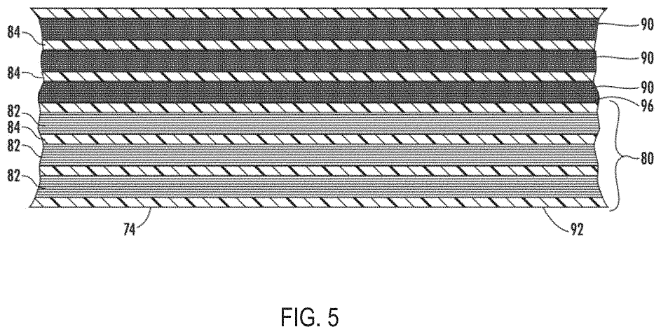

The build-up layers 90 may be formed from reinforcing fibers. For example, in come embodiments the build-up layers 90 may be formed from spiral wound braids of reinforcing fibers bonded together by the thermosetting polymeric resin 84. In other embodiments, the build-up layers 90 may be formed from a network of reinforcing fibers, such as a sheet containing reinforcing fibers. In some embodiments, one or more of the build-up layers 90 may contain shear thickening fluid. It should also be appreciated that, in certain embodiments, such as illustrated in FIG. 4, the inner most build-up layer and/or inner most layer of thermosetting polymeric resin 84 may define the inner annular surface 74. During impact, the kinetic energy may be dissipated by delamination of build-up layers 90 and core layers 82. The delaminated build-up layers 90 and core layers 82 may capture and contain impact objects. In another embodiment, shown in FIG. 5, build-up layers 90 may be bonded to an outer surface 96 of core 80. In such an embodiment, the inner surface 92 of the core 80 may define the inner annular surface 74. In still another embodiment, build-up layers 90 may be bonded to both the outer surface 96 and inner surface 92 of core 80.

In some embodiment, the inner annular surface 74 comprises one or more layers of reinforcing fibers bonded together with a thermosetting polymeric resin. The inner annular surface 74 may provide structural support and blade tip rub resistance at the inner annular surface 74 that is in closest proximity to the tips 78 of the fan blades 44 thus providing “soft wall” containment of the fan blades 44. The reinforcing fibers may include reinforcing fibers that have been impregnated with a shear thickening fluid. In certain embodiments, the reinforcing fibers include at least one fabric sheet that includes a network of reinforcing fibers that have been impregnated with shear thickening fluid.

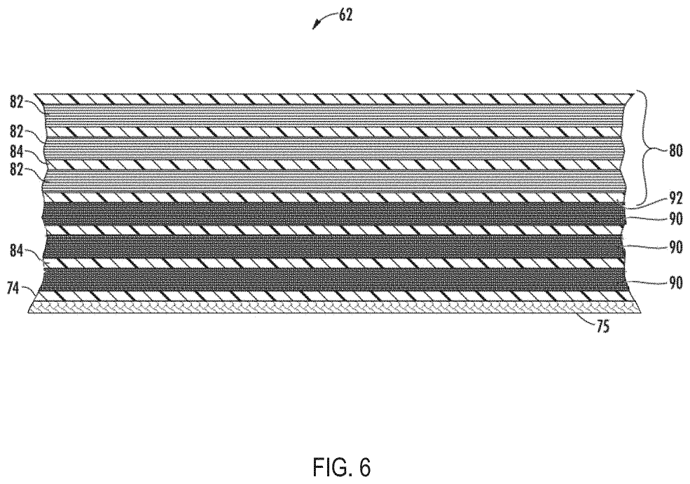

In certain embodiments, there is no intermediate structure between the tips 78 of the fan blades 44 and the inner annular surface 74. In certain embodiments, there is an intermediate structure comprising a honeycomb structure 75 provided between the inner annular surface 74 and the tips 78 of the fan blades 44. (See FIG. 6) For example, the honeycomb structure 75 may be coupled to a blade tip facing surface of the inner annular surface 74. By “blade tip facing surface” it is meant the surface of the inner annular surface 74 that is in closest proximity to the tips 78 of the fan blades 44. In certain other embodiments, the honeycomb structure 75 may comprise one or more of the layers that form the inner annular surface 74. For example, in certain embodiments the inner annular surface 74 may comprise at least one layer of honeycomb structure 75 and at least one layer of fabric sheet including a network of reinforcing fibers that have been impregnated with shear thickening fluid. The honeycomb structure 75 and fabric sheet may be bonded together via any suitable known method.

In certain embodiments, the honeycomb structure 75 may extend radially about the fan casing 62 from a location that is fore of the fan blades 44 to a location aft of the fan blades 44, thus the honeycomb structure 75 fully axially spans the length of the tips 78 of the fan blades 44. In certain embodiments, the honeycomb structure 75 may be structurally integrated to the inner annular surface 74 of the fan casing 62 and may contribute to an increase in the stiffness of the fan casing 62 and may further serve to retain blades or blade fragments in the event of an FBO event. In some embodiments, at least one of the build-up layers 90 may comprise the honeycomb structure 75 (not shown).

In certain embodiments, the honeycomb structure 75 may include any suitable honeycomb material. For example, in certain embodiments the honeycomb structure 75 may comprise a foam composite material. Suitable materials include, but are not limited to, aluminum honeycomb CR-PAA/CRIII or non-metallic honeycomb HRH-10, both manufacture by Hexcel Corporation. In certain embodiments, the honeycomb structure 75 may include a honeycomb material that formed from a paper base on aramid or glass fibers that are dipped in a phenolic resin.

Fan casing 62 may fabricated, in the exemplary embodiment, by bonding together core layers 82 and build-up layers 90 together with the thermosetting polymeric resin 84. Particularly, a mold may be used to define the desired size and shape of fan casing 62. Build-up layers 90, core layers 82, and the thermosetting polymeric resin 84 may be positioned in the mold. A vacuum may be applied to the layered structure in the mold by any suitable method, for example vacuum bagging, and heat may be applied to the structure to cure the thermosetting polymeric resin 84. Heat may be applied to the layered structure by any suitable method, for example, by placing the layered structure in a heat chamber, oven, or autoclave. The vacuum may pull the thermosetting polymeric resin 84 into and impregnate the core layers 82 to provide added strength to fan casing 62.

In some embodiments, the thermosetting polymeric resin 84 may include, as non-limiting examples, at least one of a vinyl ester resin, a polyester resin, an acrylic resin, an epoxy resin, or a polyurethane resin. Furthermore, certain materials, such as epoxy resins, which may be utilized in the thermosetting polymeric resin 84 may be inherently shear thinning, i.e., viscosity decreases with increasing rate of shear. Accordingly, while the use of such shear thinning resins may be necessary for fabricating the core of the fan casing 62, such materials may not protect the fan casing from damage due to shear events. However, incorporation of shear thickening fluids in the core layers 82, as provided herein, may offset any shear-thinning characteristics of the thermosetting polymeric resin 84 and provide for a fan casing 62 having improved properties during increased shear events.

In some embodiments, the reinforcing fibers of the core layers 82 or build-up layers 90 may include para-aramid synthetic fibers, ultra-high molecular weight polyethylene fibers, metal fibers, ceramic fibers, glass fibers, carbon fibers, boron fibers, p-phenyleneterephthalamide fibers, aromatic polyamide fibers, silicon carbide fibers, graphite fibers, nylon fibers, or mixtures thereof. In one embodiment, the reinforcing fibers may include at least one of carbide fibers, graphite fibers, glass fibers, ceramic fibers, or aromatic polyamide fibers. However, in other embodiments, any other suitable fibers in any other arrangement may be utilized to form the fan casing 62 or components thereof.

As provided herein, in some embodiments, the reinforcing fibers have been treated with or impregnated with a shear thickening fluid. In some embodiments, the shear thickening fluid may be distributed throughout a matrix or network of reinforcing fibers. In certain embodiments, one or more core layers 82 include a fabric sheet containing a network of reinforcing fibers and a shear thickening fluid.

A non-Newtonian material that exhibits time-independent viscosity is referred to as shear-thickening, as in, the apparent viscosity of the material increases in response to an increase in stress. This behavior may be particularly desirable when designing a composite fan casing to withstand sudden impacts. In general, the shear thickening fluid is non-Newtonian, dilatant, and flowable liquid containing particles suspended in a carrier whose viscosity increases with the deformation rate. These characteristics increase the energy transfer between the reinforcing fibers within the core layers 82 as the rate of deformation increases. Such energy transfer may be embodied as strain, strain rate, vibration, both frequency and magnitude dependent, pressure, energy (i.e., low force over large distance and high force over short distance both induce a response) as well as energy transfer rate (higher rates induce greater response). As such, at low deformation rates, the core layers 82 including reinforcing fibers containing the shear thickening fluid may deform as desired for handling and installation. However, at high deformation rates, such as during an impact or damage event, the core layers 82 including reinforcing fibers containing the shear thickening fluid transition to more viscous, in some cases rigid, materials with enhanced protective properties. Accordingly, the core layers 82 including reinforcing fibers impregnated with the shear thickening fluid(s) advantageously provide a structure that is workable, light and flexible during installation, but that is rigid and protective during impact.

In certain embodiments, the shear thickening fluid includes a dilatant, which possesses non-Newtonian properties in which the viscosity of the fluid increases with an increase in the rate of shear strain. A dilatant generally includes particles disbursed within a fluid (e.g., a liquid or a gas). Under one theory of shear thickening behavior, particles within a dilatant are in a state of equilibrium. So long as a critical shear rate is not exceeded, the particles will maintain an ordered equilibrium as a shear force is applied to the fluid. In other words, particles in a shear-thickening fluid will maintain Newtonian flow properties (e.g., act as a liquid), as long as the rate of an applied force does not exceed a certain threshold (i.e., the critical shear rate). However, if a dilatant experiences a shear rate greater than its critical shear rate, particles within the fluid will no longer be held in an ordered, equilibrium state, and will instead behave as a solid. This behavior is generally appreciable where large, sudden, momentary forces (e.g., object strikes, impacts, pressure oscillations, or sudden changes in acceleration) may be applied to an engine component incorporating a dilatant-impregnated matrix. With generally low profiles and high flexibility, an engine component incorporating a dilatant may additionally benefit from increased shock absorption while minimizing deleterious side-effects, such as increased engine component weight or larger profiles.

The particles contained in the dilatant may vary in size, shape, and material to suit the requirements of an engine component. Without wishing to be bound by any particular theory, it is believed that as dilatant fluid behavior is highly dependent upon the volume fraction of particles suspended within the fluid, the size or overall volume of particles influences the amount of shear required to initiate shear-thickening behavior. For gas turbine engine components, polymer particles, silica, kaolin clay, calcium carbonate, titanium dioxide, or mixtures thereof with an average diameter of about 1 nm to about 1000 μm in a flowable liquid suspended in a fluid may exhibit the desired behavior for engine components such as airfoils, casings, or structural members. The silica particles may comprise fumed silica.

In certain embodiments, the shear thickening fluid generally includes particles suspended in a flowable fluid or carrier such as a suitable solvent. Any suitable concentration of particles may be provided, and in one example, the shear thickening fluid includes at least about 50 percent by weight particles. Exemplary particles may include kaolin clay, calcium carbonate, silica, and titanium dioxide, and exemplary solvents include water and ethylene glycol. The silica particles may comprise fumed silica. The silica particles may comprise silica nanoparticles. The particles of the shear thickening fluid may be any suitable size to impregnate the reinforcing fibers or to impregnate between the reinforcing fibers. For example, the particles may be nanoparticles, having an average diameter ranging from about 1 to about 1000 nanometers, or microparticles, having an average diameter ranging from about 1 to about 1000 microns.

Further examples of the particles of the shear thickening fluid include polymers, such as polystyrene or polymethylmethacrylate, or other polymers from emulsion polymerization. The particles may be stabilized in solution or dispersed by charge, Brownian motion, and/or adsorbed. Particle shapes may include spherical particles, elliptical particles, or disk-like particles.

As described, the particles may be suspended in any suitable carrier or solvent. Suitable carriers or solvents are, in one embodiment, generally aqueous in nature (i.e., water with or without added salts, such as sodium chloride, and buffers to control pH) for electrostatically stabilized or polymer stabilized particles. In other embodiments, the solvents may be organic (such as ethylene glycol, polypropylene glycol, glycerol, polyethylene glycol, ethanol) or silicon based (such as silicon oils, phenyltrimethicone). The solvents can also comprise compatible mixtures of solvents, and may contain free surfactants, polymers, and oligomers. The solvent of the shear thickening fluid is generally stable so as to remain integral to the reinforcing fiber of the core layer 82. For a general preparation, the solvent, particles, and, optionally, a setting or binding agent are mixed and any air bubbles are removed.

In certain embodiments, the reinforcing fibers may be coated, treated, or impregnated with the shear thickening fluid via any suitable method. One exemplary method may include diluting a shear thickening fluid in ethanol, saturating the reinforcing fibers or a fabric sheet of reinforcing fibers with the shear thickening fluid that has been diluted in ethanol and placing the treated reinforcing fibers in an oven to evaporate ethanol. In this manner, the shear thickening fluid permeates the reinforcing fiber, or the fabric of reinforcing fibers and the reinforcing fiber strands are able to hold the particle-filled shear thickening fluid in place throughout the body of the reinforcing fiber and also at the end of each reinforcing fiber.

The shear thickening fluid may be embedded into the core layers 82 in a number of ways. For example, the shear thickening fluid may be applied by coating the core layer 82 with techniques such as knife-over-roller, dip, reverse roller screen coaters, application and scraping, spraying, and full immersion. The core layer 82 may undergo further operations, such as reaction/fixing (i.e., binding chemicals to the substrate), washing (i.e., removing excess chemicals and auxiliary chemicals), stabilizing, and drying. For example, the reinforcing fibers of the core layer 82 may be bound with the shear thickening fluid with a thermosetting resin that may be cured with ultraviolet (UV) or infrared (IR) radiation. Generally, such curing will not result in the hardening of the core layer 82 and the shear thickening fluid, such that the core layer 82 remains workable until installation. Additional coatings may be provided, such as to make the core layer 82 fireproof or flameproof, water-repellent, oil repellent, non-creasing, shrink-proof, rot-proof, non-sliding, fold-retaining, antistatic, or the like.

The core layer 82 may be impregnated with the shear thickening fluid prior to installation, for example, as a prepreg in which the network of reinforcing fibers impregnated with shear thickening fluid are packaged and sold as a roll of continuous material. A length of the core layer 82 may be sized, cut and installed, and as many layers as desired may follow. Because the shear thickening fluid is flowable and deformable, it can fill complex volumes and accommodate bending and rotation.

This written description uses exemplary embodiments to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A composite fan casing for a gas turbine engine defining a central axis, the composite fan casing comprising:
a core having a plurality of core layers of reinforcing fibers bonded together with a thermosetting polymeric resin, wherein one or more of the plurality of core layers of reinforcing fibers comprises a shear thickening fluid.

2. The composite fan casing of claim 1, wherein one or more of the plurality of core layers comprises at least one fabric sheet comprising a network of the reinforcing fibers.

3. The composite fan casing of claim 2, wherein the reinforcing fibers comprise para-aramid synthetic fibers, ultra-high molecular weight polyethylene fibers, metal fibers, ceramic fibers, glass fibers, carbon fibers, boron fibers, p-phenyleneterephthalamide fibers, aromatic polyamide fibers, silicon carbide fibers, graphite fibers, nylon fibers, or mixtures thereof.

4. The composite fan casing of claim 2, wherein the thermosetting polymeric resin comprises an epoxy resin.

5. The composite fan casing of claim 2, wherein the network of reinforcing fibers is impregnated with the shear thickening fluid.

6. The composite fan casing of claim 1, wherein the shear thickening fluid comprises a flowable liquid containing particles suspended in a carrier, wherein the particles have an average diameter of about 1 nm to about 1000 μm.

7. The composite fan casing of claim 6, wherein the particles comprise polymer particles, silica, kaolin clay, calcium carbonate, titanium dioxide, or mixtures thereof.

8. The composite fan casing of claim 6, wherein the carrier comprises ethylene glycol.

9. The composite fan casing of claim 1, wherein the core has a thickness of about 0.5 to 5 inches.

10. A gas turbine engine defining a central axis, the gas turbine engine comprising:
an engine shaft extending along the central axis;
a fan section including a plurality of fan blades drivingly coupled to the engine shaft, each of the fan blades extending between a root and a tip in a radial direction relative to the engine shaft;
a turbine mounted on the engine shaft to provide a rotational force to the fan section; and
a composite fan casing radially surrounding the plurality of fan blades of the fan section, the composite fan casing comprising:
a core having a plurality of core layers of reinforcing fibers bonded together with a thermosetting polymeric resin, wherein one or more of the plurality of core layers of reinforcing fibers comprises a shear thickening fluid.

11. The gas turbine engine of claim 10, wherein one or more of the plurality of core layers comprises at least one fabric sheet comprising a network of the reinforcing fibers.

12. The gas turbine engine of claim 11, wherein the reinforcing fibers comprise para-aramid synthetic fibers, ultra-high molecular weight polyethylene fibers, metal fibers, ceramic fibers, glass fibers, carbon fibers, boron fibers, p-phenyleneterephthalamide fibers, aromatic polyamide fibers, silicon carbide fibers, graphite fibers, nylon fibers, or mixtures thereof.

13. The gas turbine engine of claim 10, wherein the thermosetting polymeric resin comprises epoxy resin.

14. The gas turbine engine of claim 11, wherein the network of reinforcing fibers is impregnated with the shear thickening fluid.

15. The gas turbine engine of claim 11, wherein the shear thickening fluid comprises a flowable liquid containing particles suspended in a carrier, wherein the particles have an average diameter of about 1 nm to about 1000 μm.

16. The gas turbine engine of claim 15, wherein the particles comprise polymer particles, silica, kaolin clay, calcium carbonate, titanium dioxide, or mixtures thereof.

17. The gas turbine engine of claim 15, wherein the carrier comprises ethylene glycol.

18. The gas turbine engine of claim 10, wherein the core has a thickness of about 0.5 to about 5 inches.

19. The gas turbine engine of claim 10, wherein the composite fan casing comprises an inner annular surface, wherein the inner annular surface comprises at least one layer of a network of reinforcing fibers comprising a shear thickening fluid, wherein the reinforcing fibers comprise para-aramid synthetic fibers, ultra-high molecular weight polyethylene fibers, metal fibers, ceramic fibers, glass fibers, carbon fibers, boron fibers, p-phenyleneterephthalamide fibers, aromatic polyamide fibers, silicon carbide fibers, graphite fibers, nylon fibers, or mixtures thereof.

20. The gas turbine engine of claim 19, wherein inner annular surface further comprise a honeycomb structure.
